(19) United States
(12) Patent Application Publication
(10) Pub. No.: US 2002/0078531 A1
(43) Pub. Date: Jun. 27, 2002

(54) Tool handle

(76) Inventor: Martin Chen, Chang Hua City (TW)

Correspondence Address: RIDER BENNETT EGAN & ARUNDEL, Suite 2000, 333 South Seventh Street, Minneapolis, MN, 55402, US

(21) Appl. No.: 09/747,133

(22) Filed: Dec. 21, 2000

(51) Int. Cl. E05B 1/00

(52) U.S. Cl. 16/421

(57) ABSTRACT

A tool handle comprises an end for engaging with a tool. The tool handle comprises an upper side, an underside, and two lateral sides. The underside includes several recessed portions and several ridges. Each ridge is formed between two adjacent recessed portions. The upper side is preferably convex and includes several longitudinally spaced grooves defined therein. The grooves are preferably defined in an end of the upper side. Each lateral side of the handle and the upper side of the handle has an arcuate, smooth transition area therebetween.

### BACKGROUND OF THE INVENTION

1. Field of the Invention

The present invention relates to a tool handle with improved grasp effect, and more particularly to a tool handle for a mason's scraper that allows the user to grasp in different manners according to need, thereby providing a firm grasp effect.

2. Description of the Related Art

A typical mason's scraper includes a wooden handle, and the wooden handle may have a rubber structure attached thereto. The handle includes two flat lateral surfaces and flat upper and lower surfaces. Some of the handles are provided with small knurls on one of the surfaces of the handle to increase friction between the user's hand and the handle, yet the result is poor. It is uncommon that the scraper handle slips out of the user's hand if a relatively larger force is applied by the user to hammer an object by the handle or scrape redundant cement by the blade of the scraper. The user might be injured accordingly.

### SUMMARY OF THE INVENTION

A tool handle in accordance with the present invention comprises an end for engaging with a tool. The tool handle comprises an upper side, an underside, and two lateral sides. The underside includes a plurality of recessed portions and a plurality of ridges. Each ridge is formed between two adjacent recessed portions.

The upper side is preferably convex and includes a plurality of longitudinally spaced grooves defined therein. The grooves are preferably defined in an end of the upper side. Each lateral side of the handle and the upper side of the handle has an arcuate, smooth transition area therebetween. Preferably, the underside of the tool handle includes four recessed portions and three ridges.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a tool handle in accordance with the present invention.

FIG. 2 is a side view of the tool handle in accordance with the present invention.

FIG. 3 is a top view of the tool handle in accordance with the present invention.

FIG. 4 is a perspective view of the tool handle, wherein a blade is attached to the tool handle to form a scraper.

FIG. 5 is a perspective view illustrating a method for holding the tool handle in accordance with the present invention.

FIG. 6 is a top view illustrating another method for holding the tool handle in accordance with the present invention.

FIG. 7 is a side view of FIG. 6.

### DETAILED DESCRIPTION OF THE PREFERRED EMBODIMENT

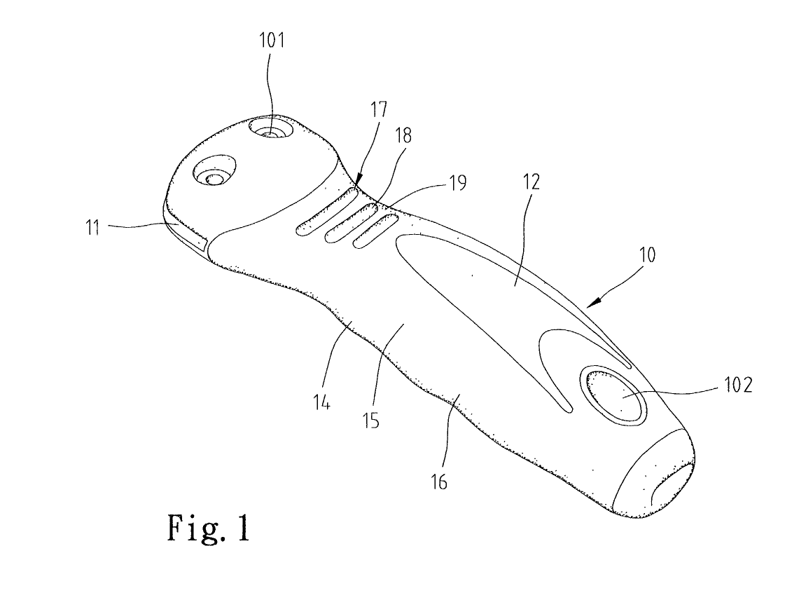

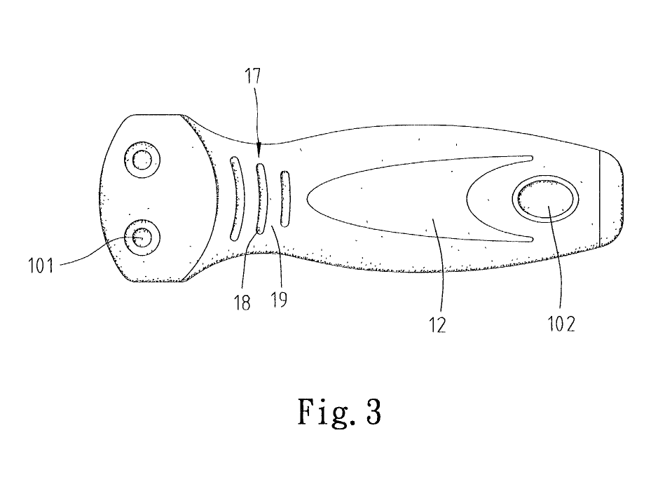

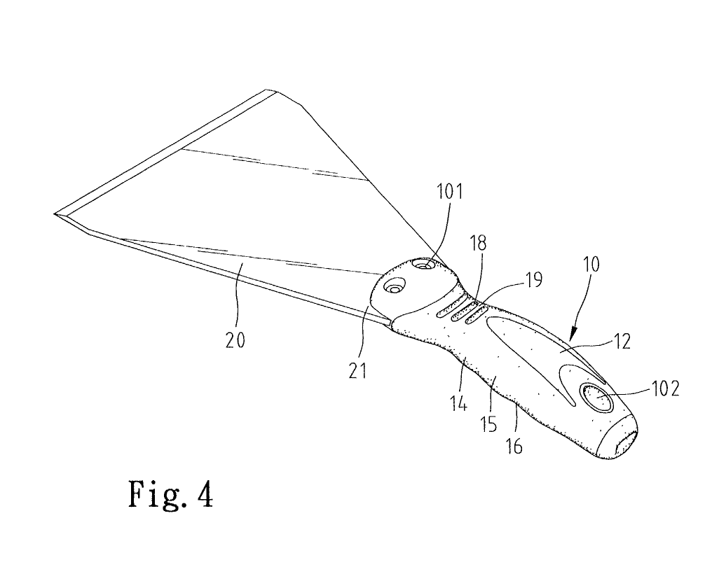

Referring to FIGS. 1 through 3, a tool handle 10 in accordance with the present invention generally includes a first end having an engaging groove 11 for engaging with a tool, e.g., a blade 20 (FIG. 4). A transverse hole 102 is defined in a second end of the tool handle 10 such that the tool handle 10 can be hung up to, e.g., a nail (not shown) on a wall (not shown). Alternatively, a string (not shown) can be stringed through the transverse hole 102 to allow easy carriage of the tool handle 10. Of course, the tool handle 10 can be hung up to a nail on a wall by the string.

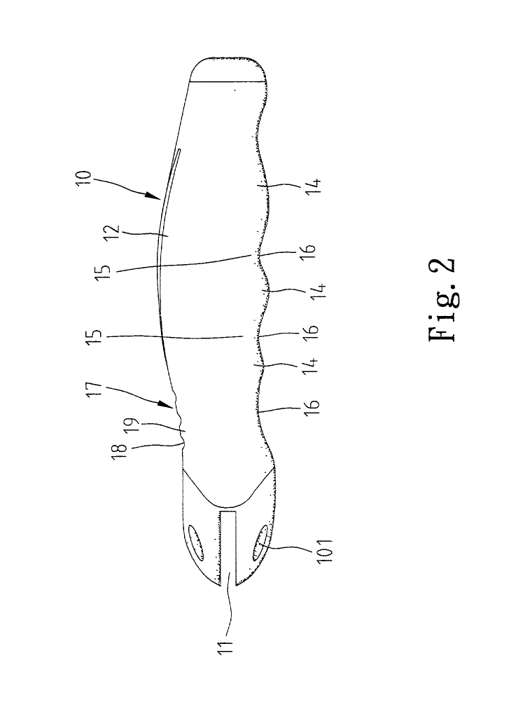

The tool handle 10 includes an upper side 12, an underside, and two lateral sides (not labeled). A plurality of longitudinally spaced grooves 18 is defined in the upper side 12 and adjacent to the first end of the tool handle 10. Each two adjacent grooves 18 have a protruded portion 19 therebetween. Thus, as illustrated in FIG. 2, a wave-like anti-slip portion 17 is formed on the upper side 12, the purpose of which will be described later.

As illustrated in FIG. 2, the underside of the tool handle includes four recessed portions 16 and three ridges 14 among the recessed portions. Namely, each ridge 14 is provided between two adjacent recessed portions 16. This allows the user to grasp the tool handle 10 more firmly. In addition, the upper side 12 is convex to be in intimate contact with the palm of the user. Furthermore, a transition area 15 between each lateral side of the handle and the upper side 12 of the handle is arcuate and smooth.

FIG. 4 illustrates an embodiment of the invention, wherein a blade 20 is attached to the handle 10 to form a mason's scraper. Screws (not shown) are extended through holes 101 in the first end of the tool handle 101 and holes (not shown) in an end of the blade 20, thereby securely attaching the blade 20 to the handle 10.

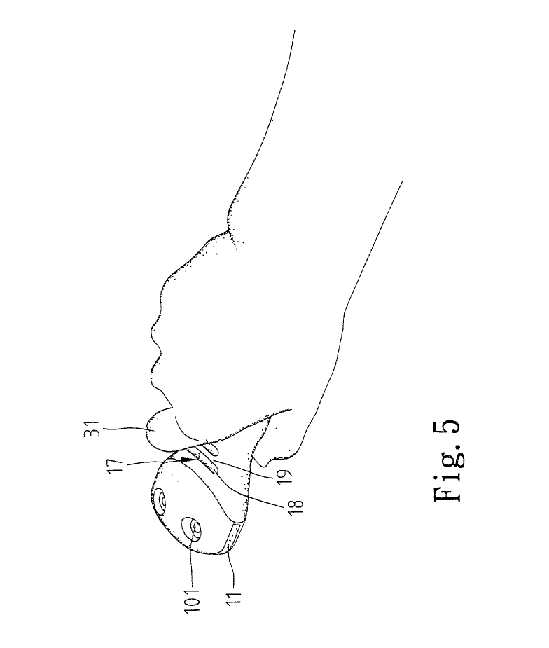

Referring to FIG. 5, the user's hand 30 may firmly grasp the tool handle with each finger 31 (except the thumb) snugly located in an associated recessed portion 16. Thus, each finger 31 will be located between two ridges 14, thereby providing a firm grasp. The recessed portions 16 and the ridges 14 are configured corresponding to the profiles of the human fingers, thereby providing an ergonomic design which provides firm, reliable grasp for the tool handle 10. It is noted that the arcuate transition area 15 between the left lateral side (see FIG. 5) of the handle 10 and the upper side 12 of the handle 10 is in intimate contact with a portion of the user's palm. This further assures a firm grasp.

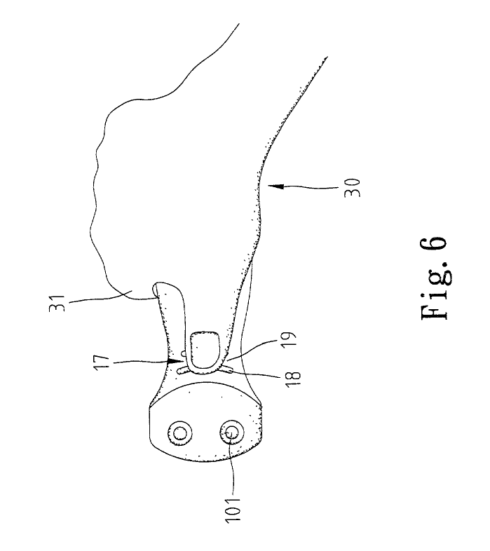

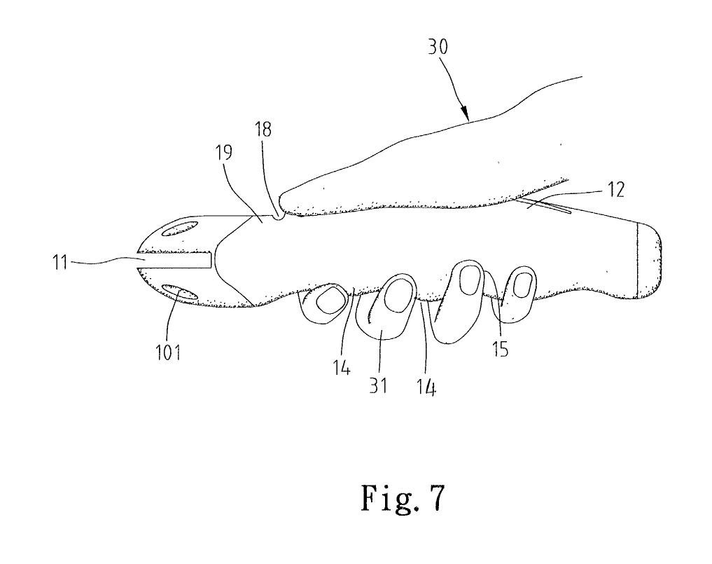

FIGS. 6 and 7 illustrate another method for grasping the tool handle 10, wherein the thumb is placed on the anti-slip portion 17 formed by the grooves 18 and the protruded portions 19, and each of the other fingers 31 are located in an associated recessed portion 16. When a blade (e.g., blade 20 in FIG. 4) is attached to the tool handle to form a scraper, and when the scraper is used to, e.g., scrape redundant cement from a wall surface, the user may grasp the tool handle 10 in a manner shown in FIGS. 6 and 7 without the risk of disengagement of the tool handle 10 from the hand, even though a relatively large force is applied. It is noted that the arcuate transition area 15 between the right lateral side of the handle 10 and the upper side 12 of the handle 10 is in intimate contact with another portion of the user's palm. This further assures a firm grasp.

Although the invention has been explained in relation to its preferred embodiment, it is to be understood that many other possible modifications and variations can be made without departing from the scope of the invention as hereinafter claimed.

What is claimed is:

1. A tool handle comprising an end adapted to engage with a tool, the tool handle comprising an upper side, an underside, and two lateral sides, the underside including a plurality of recessed portions and a plurality of ridges, each said ridge being formed between two adjacent said recessed portions.

2. The tool handle as claimed in claim 1, wherein the upper side includes a plurality of longitudinally spaced grooves defined therein.

3. The tool handle as claimed in claim 2, wherein the grooves are defined in an end of the upper side.

4. The tool handle as claimed in claim 1, wherein each said lateral side of the handle and the upper side of the handle has an arcuate, smooth transition area therebetween.

5. The tool handle as claimed in claim 1, wherein the upper side is convex.

6. The tool handle as claimed in claim 5, wherein the upper side includes a plurality of longitudinally spaced grooves defined therein.

7. The tool handle as claimed in claim 6, wherein the grooves are defined in an end of the upper side.

8. The tool handle as claimed in claim 5, wherein each said lateral side of the handle and the upper side of the handle has an arcuate, smooth transition area therebetween.

9. The tool handle as claimed in claim 7, wherein each said lateral side of the handle and the upper side of the handle has an arcuate, smooth transition area therebetween.

10. A tool handle comprising an end adapted to engage with a tool, the tool handle comprising an upper side, an underside, and two lateral sides, the underside including four recessed portions and three ridges, each said ridge being formed between two adjacent said recessed portions.
